(19) United States
(12) Patent Application Publication
(10) Pub. No.: US 2025/0286977 A1
(43) Pub. Date: Sep. 11, 2025

(54) COLOR MATCHING FOR A PRINTER

(71) Applicant: Marcel Stoica, Timisoara (RO)

(72) Inventor: Marcel Stoica, Timisoara (RO)

(73) Assignee: Ricoh Company, Ltd., Tokyo (JP)

(21) Appl. No.: 18/597,715

(22) Filed: Mar. 6, 2024

(51) Int. Cl. H04N 1/60; G01J 3/46; G01J 3/52

(52) U.S. Cl. CPC H04N 1/6033; G01J 3/462; G01J 3/463; G01J 3/524

(57) ABSTRACT

Systems and methods for color matching. In an embodiment, a method comprises loading a color sample file of a color sample that includes color measurements, and generating a patch chart image by processing the color measurements for the color sample to select target colors, and generating the patch chart image comprising color patch objects corresponding with the target colors. The method further comprises printing the patch chart image at a target printer to output a patch chart, scanning the patch chart to generate color measurements for the patch chart, generating a color matching profile for the target printer based on the color measurements for the color sample and the color measurements for the patch chart, and registering the color matching profile at the target printer.

### TECHNICAL FIELD

The following disclosure relates to the field of printing, and in particular, to color management in printing.

### BACKGROUND

Print systems transform a print job into a printed output by applying colorant(s) to mark a printable medium, such as paper. In order to represent colors specified in the print job, a printer may utilize different colorants that are applied to the medium in different ratios. For instance, a CMYK (Cyan, Magenta, Yellow, Key black) printer utilizes combinations of four different colorants to represent the input colors specified in the print job as output colors. The output colors (also referred to as the color space) producible by printers may vary for a variety of reasons, such as bit depth, temperature, types of colorants used, etc.

Printers, which are not calibrated from a color perspective, may reproduce different results while printing the same digital document. To level the colors onto printers, color calibration techniques may be applied by creating and using International Color Consortium (ICC) color profiles specific for each printer. Even when calibration of a single printer could be performed targeting different goals, some print shops may want to save as much as possible on colored inks (e.g., maximizing the use of black as much as possible), while others may be interested in color fidelity, etc. Tuning the colors and leveling them across the print shop is difficult and complex. In the scenarios of having a physical sample printed in unknown conditions/printer configuration, such as when printed by a different print shop, the task of replicating the same results onto a different printer may be performed using a color matching technique and a spectrometer device. In a present color matching technique, the physical sample printed in unknown conditions (e.g., different print shop), referred to as a “golden sample”, is scanned and colors of the physical sample are measured with a spectrometer device. The same digital document is printed using a target printer and the output (referred to as a “before-matching sample”) is scanned and colors of the before-matching sample are measured using the same spectrometer device. The colors between the golden sample and the before-matching sample are compared and a delta color difference calculated, resulting in a correctional ICC profile specific for the job. Using the correctional ICC profile, the printer can replicate the colors of the golden sample.

One potential issue is it may be difficult to map the scanned version of the golden sample to the scanned version of the before-matching sample to perform the comparison. For example, the golden sample and/or the before-matching sample may be shifted or rotated when scanning, there may be differences in size and/or resolution of the color samples, etc. Thus, it is desirable to identify improved color matching processes for print systems.

### SUMMARY

Embodiments described herein provide enhanced color matching. As a general overview, a color sample is obtained, which represents the benchmark for color matching (e.g., a golden sample). The color sample is scanned to generate color measurements for the color sample, and the color measurements for the color sample are processed to identify or select target colors in the color sample to be used in color matching. A patch chart image is generated from the target colors, and is printed at a target printer to output a patch chart. The printed patch chart is then scanned (e.g., with a spectrometer device or the like) to generate color measurements for the patch chart. The color measurements for the patch chart and the color measurements for the color sample are compared to generate a color matching profile for the target printer. The color matching profile may then be registered at the target printer for color-matched printing. One technical benefit is the color matching process focuses on matching to the colors found in the color sample, rather than performing pixel matching between two scanned images (e.g., a scanned version of the golden sample and a scanned version of the before-matching sample). Therefore, the color matching process is more tolerant to scan errors, size or resolution differences, or other conditions that may exist, and may provide more accurate color matching.

In an embodiment, a method of color matching is disclosed. The method comprises loading a color sample file of a color sample, where the color sample file includes color measurements for the color sample. The method further comprises generating a patch chart image by processing the color measurements for the color sample to select target colors from the color sample, and generating the patch chart image comprising color patch objects corresponding with the target colors. The method further comprises printing the patch chart image at a target printer to output a patch chart that includes a plurality of color patches corresponding with the color patch objects, scanning the patch chart to generate color measurements for the patch chart, generating a color matching profile for the target printer based on the color measurements for the color sample and the color measurements for the patch chart, and registering the color matching profile at the target printer for color-matched printing at the target printer.

In an embodiment, a color matching apparatus comprises at least one processor and memory. The at least one processor is configured to cause the color matching apparatus at least to receive a color sample file of a color sample, where the color sample file includes color measurements for the color sample. The at least one processor is configured to cause the color matching apparatus at least to generate a patch chart image by processing the color measurements for the color sample to select target colors from the color sample, and generating the patch chart image comprising color patch objects corresponding with the target colors. The at least one processor is configured to cause the color matching apparatus at least to provide an instruction to print the patch image at a target printer to output a patch chart, where the patch chart includes a plurality of color patches corresponding with the color patch objects. The at least one processor is configured to cause the color matching apparatus at least to provide an instruction to scan the patch chart to generate color measurements for the patch chart, receive the color measurements for the patch chart, generate a color matching profile for the target printer based on the color measurements for the color sample and the color measurements for the patch chart, and register the color matching profile at the target printer for color-matched printing at the target printer.

Other embodiments may include computer readable media, other systems, or other methods as described below.

The above summary provides a basic understanding of some aspects of the specification. This summary is not an extensive overview of the specification. It is intended to neither identify key or critical elements of the specification nor delineate any scope particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 is a diagram of a print system in an illustrative embodiment.

FIG. 2 is a schematic diagram of an image forming apparatus in an illustrative embodiment.

FIG. 3 is a block diagram of a management server in an illustrative embodiment.

FIG. 4 is a flow chart illustrating a method of performing color matching in an illustrative embodiment.

FIG. 5 illustrates a color sample.

FIG. 6 is a schematic diagram illustrating a color matching unit loading a color sample file in an illustrative embodiment.

FIG. 7 is a schematic diagram illustrating a color matching unit generating a patch chart image in an illustrative embodiment.

FIG. 8 is a schematic diagram illustrating printing of a patch chart image in an illustrative embodiment.

FIG. 9 is a schematic diagram illustrating scanning of a patch chart in an illustrative embodiment.

FIG. 10 is a schematic diagram illustrating a color matching unit generating a color matching profile in an illustrative embodiment.

FIG. 11 is a schematic diagram illustrating a color matching unit registering a color matching profile at a target printer in an illustrative embodiment.

FIGS. 12A-12C are flow charts illustrating a method of generating a patch chart image in an illustrative embodiment.

FIG. 13 is a diagram illustrating a sample color list and a target color list in an illustrative embodiment.

FIG. 14 is a diagram illustrating a patch chart image in an illustrative embodiment.

FIG. 15 is a diagram illustrating a sample color list and a target color list in an illustrative embodiment.

FIG. 16 is a diagram illustrating a patch chart in an illustrative embodiment.

FIG. 17 is a flow chart illustrating a method of color matching within a color matching unit in an illustrative embodiment.

FIG. 18 is a diagram illustrating a color matching screen in an illustrative embodiment.

FIG. 19 is a diagram illustrating a color matching screen in an illustrative embodiment.

FIG. 20 is a diagram illustrating a color matching screen in an illustrative embodiment.

FIG. 21 is a diagram illustrating a color matching screen in an illustrative embodiment.

FIG. 22 illustrates a processing system operable to execute a computer readable medium embodying programmed instructions to perform desired functions in an illustrative embodiment.

### DETAILED DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

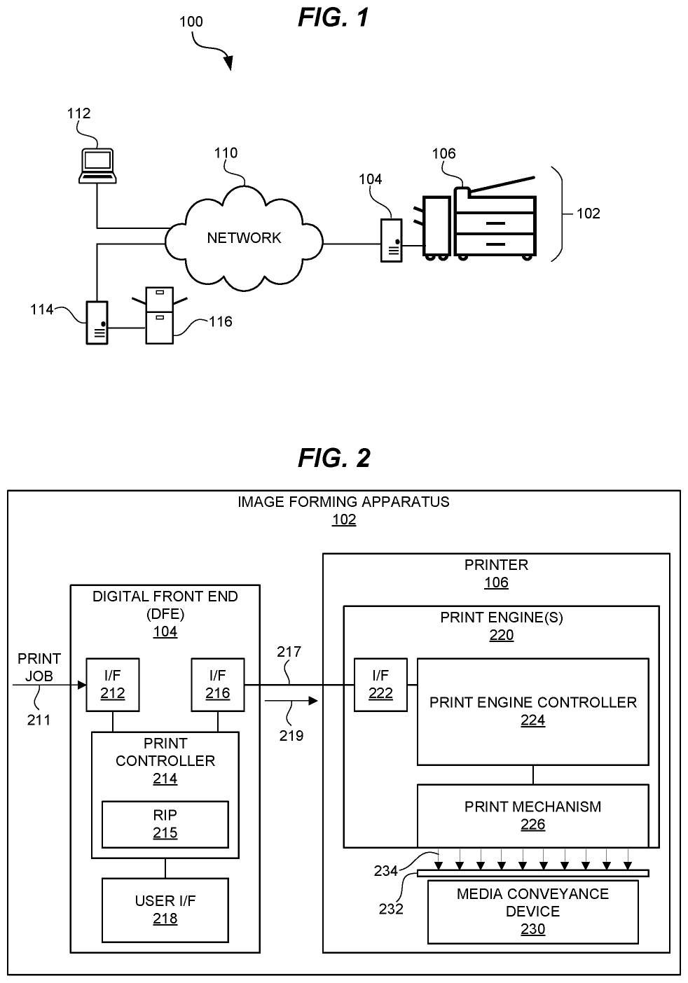

FIG. 1 is a diagram of a print system 100 in an illustrative embodiment. As one example in FIG. 1, print system 100 may include an image forming apparatus 102, a client terminal 112 (e.g., a personal computer (PC)), a management server 114 (also referred to as a print server), and a scanner 116. As illustrated in FIG. 1, one or more of the devices of print system 100 are able to perform data communication with one another via a network 110. The network 110 may comprise, for example, a network including a local area network (LAN), a wide area network (WAN), such as the Internet, etc., and may comprise a wired network, a wireless network, or a network including both of a wired network and a wireless network.

Image forming apparatus 102 includes a digital front end (DFE) 104 and a printer 106. In an example, printer 106 may comprise an apparatus that performs image formation (printing) on a recording medium by applying colorants on the basis of print data received from the DFE 104. DFE 104 is an information processing apparatus that receives a print job (e.g., from the client terminal 112 or management server 114), generates print data by a raster image processor (RIP) engine on the basis of the print job, and transmits the print data to the printer 106. In an embodiment, DFE 104 may be on-ground or on-premises with printer 106. In general, “on-premises” means that the infrastructure exists on-site in contrast to being hosted off-site. DFE 104 may be implemented on a separate (on-premises) platform from printer 106, or may be integrated on a platform of the printer 106. In an embodiment, DFE 104 may communicate with printer 106 over network 110.

The client terminal 112 is an information processing apparatus that generates a print job to be printed by a user, and transmits the print job to the DFE 104 or the management server 114. The management server 114 is a server apparatus that manages the print job received from the client terminal 112, and transmits the print job to the DFE 104, such as in response to a request from the DFE 104. Scanner 116 is a color measurement apparatus that performs a read operation on a recording medium on which a printed image is formed to capture and evaluate colors on the printed image, and to output color measurements for the colors on the printed image. For example, scanner 116 may comprise a spectrophotometric color measuring device (referred to generally as a spectrometer device) configured to capture and evaluate colors on the printed image. Scanner 116 may be directly connected to management server 114, may be connected to management server 114 over network 110, or may be connected to other devices.

FIG. 2 is a schematic diagram of image forming apparatus 102 in an illustrative embodiment. Image forming apparatus 102 is a type of device that executes an image forming process (e.g., printing) on a recording medium. In an embodiment, image forming apparatus 102 includes DFE 104, and the printer 106 comprising one or more print engines 220. DFE 104 comprises an apparatus, device, circuitry, means, and/or other component configured to accept a print job 211, and convert the print job 211 into a suitable format for print engine 220. DFE 104 includes an Input/Output (I/O) interface 212, a print controller 214, and a print engine interface 216, and may also include a user interface 218. I/O interface 212 comprises an apparatus, device, circuitry, means, and/or other component configured to receive a print job 211 from a source, such as a client terminal 112, a management server 114, etc. I/O interface 212 may be considered a network interface in some embodiments. The print job 211 comprises one or more job files or vector files formatted with a Page Description Language (PDL), such as PostScript, Printer Command Language (PCL), Intelligent Printer Data Stream (IPDS), etc. The print job 211 may also comprise a job ticket containing instructions, requirements, and/or other control information for processing and/or printing a print job, such as a Job Definition Format (JDF) job ticket. Print controller 214 comprises an apparatus, device, circuitry, means, and/or other component configured to transform the print job 211 into print data 219 comprising one or more digital images that may be used by print engine 220 to mark a recording medium 232 with ink, toner, or another recording or marking material. In an embodiment, print controller 214 includes a Raster Image Processor (RIP) 215 that translates or rasterizes the print job 211 to generate digital images or raster images that a printer can understand and print. A digital or raster image comprises a two-dimensional array of pixels or dots, also referred to as a bitmap. Whereas the job file(s) of the print job 211 in PDL format is a high-level description of the content (e.g., text, graphics, pictures, etc.), a digital image defines a pixel value or color value for each pixel in a display space. Print engine interface 216 comprises an apparatus, device, circuitry, means, and/or other component configured to communicate with print engine 220, such as to transmit digital images to print engine 220. Print engine interface 216 may be communicatively coupled to print engine 220 via one or more communication links 217 (e.g., a fiber link, a bus, a communication cable, etc.), and is configured to transfer the digital images to print engine 220. User interface 218 is a component configured to interact with a human operator. A human operator may access user interface 218 to view status indicators or updates, view or manipulate settings, schedule print jobs, etc.

Printer 106 may comprise a cut-sheet printer, a continuous-form printer that prints on a web of continuous-form media, a wide format printer, etc. Print engine 220 includes a DFE interface 222, a print engine controller 224, and a print mechanism 226. DFE interface 222 comprises an apparatus, device, circuitry, means, and/or other component configured to interact with DFE 104, such as to receive print data 219 from DFE 104. Print engine controller 224 comprises an apparatus, device, circuitry, means, and/or other component configured to process the print data 219 (e.g., the digital or raster images) received from DFE 104, and provide control signals to print mechanism 226. Print mechanism 226 is an image formation device (or devices) that mark the recording medium 232 with a recording material 234 or colorant, such as ink. Print mechanism 226 may be configured for variable droplet or dot size to reproduce multiple intensity levels. Recording medium 232 comprises any type of material suitable for printing upon which recording material 234 is applied, such as paper (web or cut-sheet), plastic, card stock, transparent sheets, cloth, etc. In an embodiment, print mechanism 226 may include one or more printheads that are configured to jet or eject droplets of a print fluid, such as ink (e.g., water, solvent, oil, or UV-curable), through a plurality of orifices or nozzles. The orifices or nozzles may be grouped according to ink types (e.g., colors such as Cyan (C), Magenta (M), Yellow (Y), Key black (K) or formulas such as for pre-coat, image and protector coat, etc.), which may be referred to as color planes. In another embodiment, print mechanism 226 may include a drum that selectively collects electrically-charged powdered ink (toner), and transfers the toner to recording medium 232. Media conveyance device 230 may be configured to move recording medium 232 relative to print mechanism 226. In other embodiments, portions of print mechanism 226 may be configured to move relative to recording medium 232. Image forming apparatus 102 may include various other components not specifically illustrated in FIG. 2.

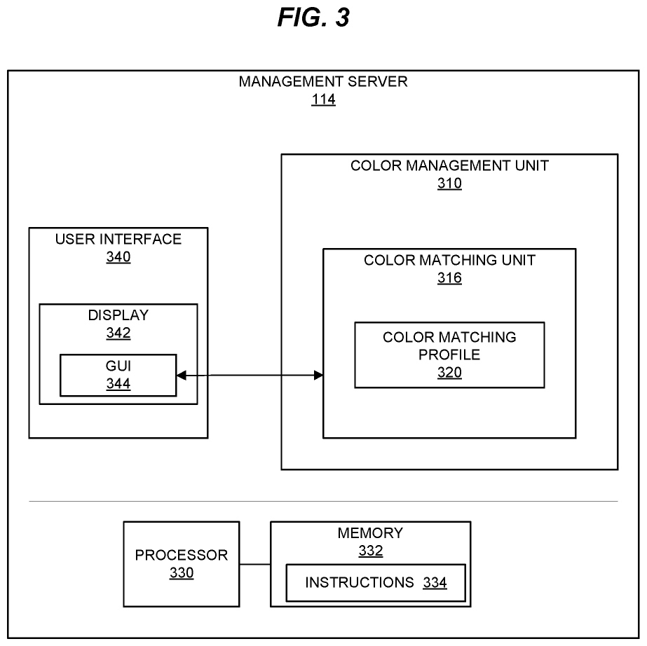

FIG. 3 is a block diagram of management server 114 in an illustrative embodiment. Management server 114 includes or implements a color management unit 310, which comprises an apparatus, device, circuitry, means, and/or other component configured to perform color management for an image forming apparatus 102 (e.g., printer 106). In general, color management is a process or procedure of ensuring consistent and/or accurate colors, such as at a printer. Different printers 106 may have different color capabilities and characteristics. Thus, the printed output of a common image produced from different printers 106 may be inconsistent. In image forming apparatuses, color management may be performed to suppress variations in printed output due to device-specific characteristics and enhance the reproducibility of printed output.

In an embodiment, color management unit 310 may include a color matching unit 316, which comprises an apparatus, device, circuitry, means, and/or other component configured to perform color matching. Color matching unit 316 is configured to generate a color matching profile 320 (i.e., an ICC profile) for a printer 106 based on a color sample. The color matching profile 320 may then be used in the printer 106 to reproduce the colors of the color sample on printed output as closely as possible.

In an embodiment, management server 114 may further include a user interface 340. User interface 340 is an information processing apparatus configured to interact with an end user. For example, user interface 340 may include a display 342, screen, touch screen, or the like (e.g., a Liquid Crystal Display (LCD), a Light Emitting Diode (LED) display, etc.). User interface 340 may include a keyboard or keypad, a tracking device (e.g., a trackball or trackpad), a speaker, a microphone, etc. Color matching unit 316 may be configured to interact with user interface 340 regarding a color matching process. Thus, user interface 340 may provide or display a Graphical User Interface (GUI) 344 generated by color matching unit 316 for the color matching process, an example of which is further described below.

Management server 114 may include one or more processors 330 and a memory 332. Processor 330 represents the internal circuitry, logic, hardware, etc., that provides the functions of management server 114. Processor 330 may be configured to execute instructions 334 (i.e., computer program code) for software that are loaded into memory 332. Processor 330 may comprise a microprocessor, a set of one or more processors, or may comprise a multi-processor core depending on the particular implementation. Memory 332 is a computer readable storage medium for data, instructions 334, applications, etc., and is accessible by processor 330. Memory 332 is a hardware storage device capable of storing information on a temporary basis and/or a permanent basis. Memory 332 may comprise volatile or non-volatile Random-Access Memory (RAM), Read-Only Memory (ROM), FLASH devices, volatile or non-volatile Static RAM (SRAM) devices, magnetic disk drives, Solid State Disks (SSDs), or any other volatile or non-volatile storage device. Management server 114 may include other components or devices not shown in FIG. 3.

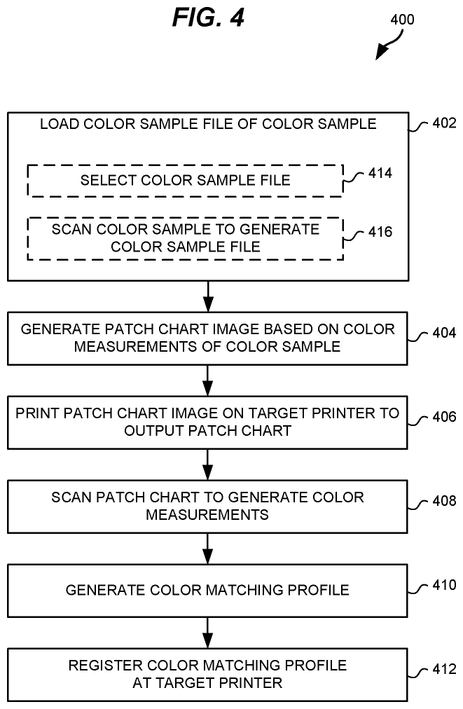

FIG. 4 is a flow chart illustrating a method 400 of performing color matching in an illustrative embodiment. Method 400 will be discussed with respect to print system 100 of FIG. 1, although method 400 may be performed by other systems, not shown. The steps of the flow charts described herein may include other steps that are not shown. Also, the steps of the flow charts described herein may be performed in an alternate order.

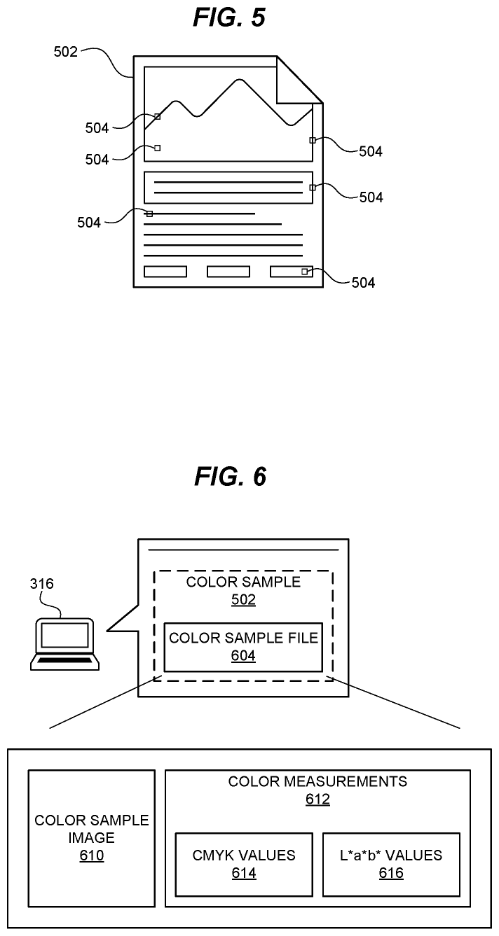

In general, method 400 describes an operation workflow for color matching. Color matching operates using a color sample, which is a physical sample (e.g., a preprinted document) representing a desired, preferred, or approved printed output. For example, a color sample may comprise a golden sample, which is used in production processes to represent an approved final sample or ideal representation of a printed product. A color sample that is used for color matching (i.e., represents the benchmark for color matching) may be referred to herein as an “original” color sample. FIG. 5 illustrates a color sample 502. Color sample 502 is a physical document (i.e., one or more pages or sheets) preprinted with text, images, etc., and comprising a plurality of colors 504 (which may be referred to as “original” colors).

In FIG. 4, color matching unit 316 loads a color sample file of the color sample 502 (step 402). FIG. 6 is a schematic diagram illustrating color matching unit 316 loading a color sample file 604 in an illustrative embodiment. In one example, color sample 502 may have been previously scanned and processed (i.e., color measurement) to generate color sample file 604, which is stored in memory. Therefore, color sample file 604 may be loaded by selecting the color sample file 604 from a memory location (optional step 414 in FIG. 4). In another example, color sample 502 may be scanned and processed (e.g., at scanner 116) to generate color sample file 604 (optional step 416 in FIG. 4). In this example, the scanner 116 captures and evaluates colors on the color sample 502, and outputs color measurements contained in the color sample file 604. Color sample file 604 may include a digital image of the color sample 502 (i.e., color sample image 610), such as produced by scanning the color sample 502. Color sample file 604 further includes color measurements 612 generated or computed from the color sample 502. For example, the color measurements 612 may include CMYK values 614 in the CMYK color space, and/or L*a*b* values 616 in the CIELAB color space, although other types of measurements are considered herein.

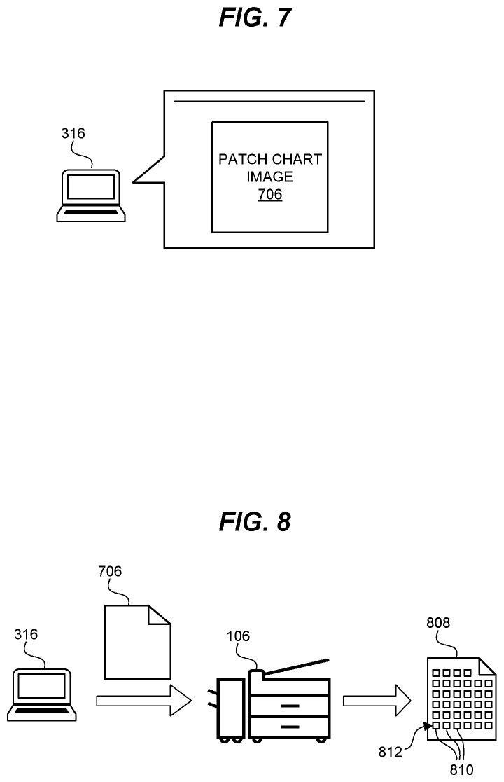

Color matching unit 316 then processes or otherwise evaluates the color measurements 612 of the color sample 502. In FIG. 4, color matching unit 316 generates a patch chart image based on the color measurements 612 of the color sample 502 (step 404). FIG. 7 is a schematic diagram illustrating color matching unit 316 generating a patch chart image 706 in an illustrative embodiment. In general, color sample 502 includes a plurality of colors 504 identifiable from the color measurements 612. Color matching unit 316 generates a patch chart image 706 comprising color patch objects corresponding with the colors 504 (some or all) identified in the color sample 502. For example, if Color1 is identified in color sample 502 (e.g., with CMYK value 614=C1, M1, Y1, K1), then patch chart image 706 may include a color patch object corresponding with Color1. If Color2 is identified in color sample 502 (e.g., with CMYK value 614=C2, M2, Y2, K2), then patch chart image 706 may include a color patch object corresponding with Color2. A patch chart generation process for generating the patch chart image is described in further detail below. The patch chart image 706 generated by color matching unit 316 may be referred to as an “original” patch chart image.

In FIG. 4, the patch chart image 706 is printed at a target printer 106 to output a patch chart (step 406). The target printer 106 is the printer upon which color matching is being performed. FIG. 8 is a schematic diagram illustrating printing of a patch chart image 706 in an illustrative embodiment. The patch chart image 706 is sent to the target printer 106, which in turn prints the patch chart image 706 to generate, produce, or output a patch chart 808. As will be described in more detail below, patch chart 808 is a physical document (i.e., one or more pages or sheets) that includes a plurality of color patches 810 (printed versions of the color patch objects in the patch chart image 706). Each color patch 810 represents an actual color 812 (also referred to as a printed color, a reproduced color, etc.) reproduceable by the target printer 106. For example, if the patch chart image 706 includes a color patch object corresponding with Color1, then the patch chart 808 includes a color patch 810 corresponding with or mapped to Color1 but represents an actual color 812 reproducible by the target printer 106. If the patch chart image 706 includes a color patch object corresponding with Color2, then the patch chart 808 includes a color patch 810 corresponding with or mapped to Color2 but represents an actual color 812 reproducible by the target printer 106. Thus, the actual colors 812 printed in the color patches 810 may or may not match corresponding colors 504 of the color sample 502.

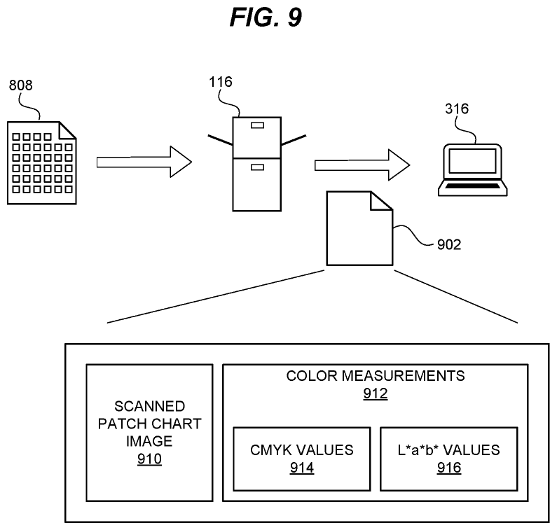

In FIG. 4, the printed patch chart 808 is scanned (e.g., at scanner 116) to generate or compute color measurements for the patch chart 808 (step 408). FIG. 9 is a schematic diagram illustrating scanning of a patch chart 808 in an illustrative embodiment. For example, the patch chart 808 is loaded on scanner 116, which scans and processes the patch chart 808 to generate a patch chart file 902 (also referred to as a scanned patch chart file). Scanner 116 captures and evaluates the actual colors 812 on the patch chart 808, and outputs color measurements for the actual colors 812 on the patch chart 808 (i.e., contained in the patch chart file 902). Patch chart file 902 may include a digital image of the patch chart 808 (i.e., scanned patch chart image 910), such as produced by scanning the patch chart 808. Patch chart file 902 further includes color measurements 912 generated or computed from the patch chart 808. For example, the color measurements 912 may include CMYK values 914 in the CMYK color space, and/or L*a*b* values 916 in the CIELAB color space, although other types of measurements are considered herein. Patch chart file 902 is then loaded at color matching unit 316.

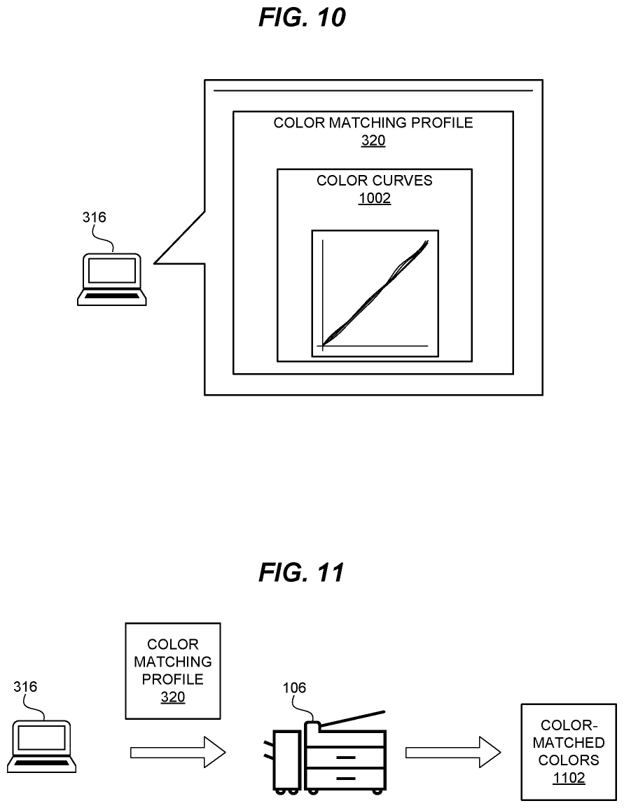

In FIG. 4, color matching unit 316 generates a color matching profile 320 for the target printer 106 based on the color measurements 612 for the color sample 502 and the color measurements 912 for the patch chart 808 printed at the target printer 106 (step 410). FIG. 10 is a schematic diagram illustrating color matching unit 316 generating a color matching profile 320 in an illustrative embodiment. For example, color matching unit 316 may compare the L*a*b* values 616 for the color sample 502 and the L*a*b* values 916 for the patch chart 808 to determine deviations between the colors 504 of the color sample 502 and the actual colors 812 of the patch chart 808 printed by the target printer 106. Color matching unit 316 may then generate or adjust CMYK color curves 1002 for the target printer 106.

In FIG. 4, color matching unit 316 may then register the color matching profile 320 at the target printer 106 for color-matched printing (step 412). FIG. 11 is a schematic diagram illustrating color matching unit 316 registering the color matching profile 320 at the target printer 106 in an illustrative embodiment. For example, color matching unit 316 may send the color matching profile 320 to the target printer 106, which is registered or loaded at the target printer 106, such as at the print engine controller 224 (see FIG. 2). The target printer 106 may then print using colors that are adjusted based on the color matching profile 320, which may generally be referred to as color-matched colors 1102. One assumption is that the target printer 106 allows for an adjustable ICC profile. Print engine controller 224, for example, may use the color matching profile 320 when rendering digital images for printing at the print mechanism 226. The color-matched colors 1102 output by the print mechanism 226 should therefore match the colors 504 of the color sample 502 as closely as possible. Color matching unit 316 may send the color matching profile 320 along with a print job 211 to the target printer 106 as a bundle, or may send the color matching profile 320 and the print job 211 separately.

One technical benefit is the color-matched colors 1102 output by the target printer 106 (based on the color matching profile 320) approximate the colors 504 of the color sample 502 as closely as possible by using the color matching process. The color matching process focuses on matching to the colors 504 found in the color sample 502, rather than performing pixel matching between two scanned images (e.g., a scanned version of the golden sample and a scanned version of the before-matching sample). Therefore, the color matching process is more tolerant to scan errors, size or resolution differences, or other conditions that may exist, and may provide more accurate color matching.

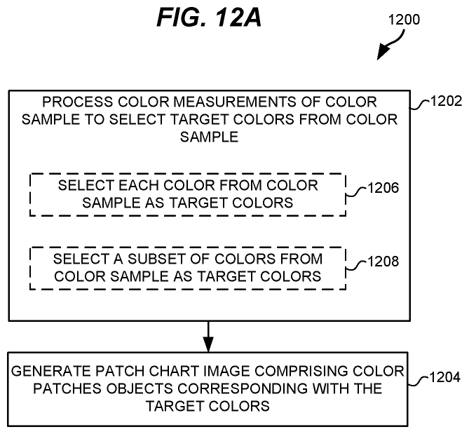

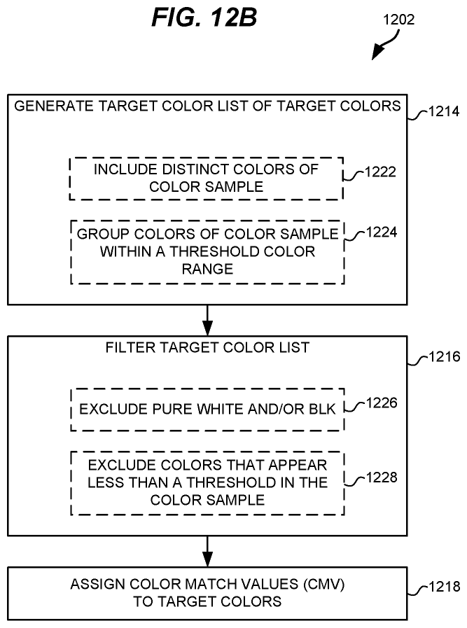

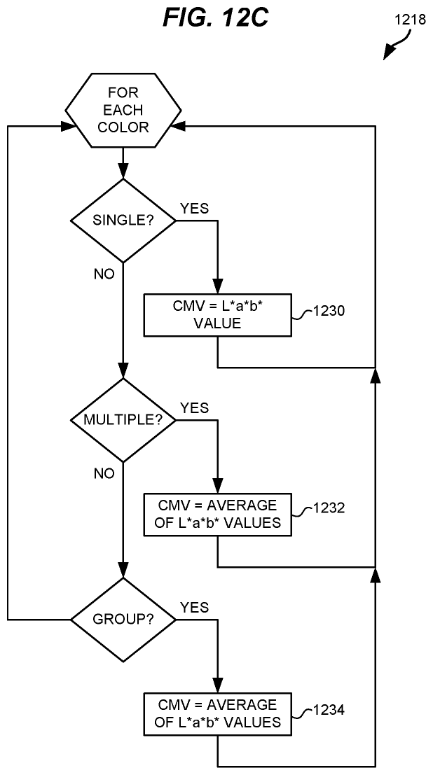

FIGS. 12A-12C are flow charts illustrating a method 1200 of generating a patch chart image 706 in an illustrative embodiment. Method 1200 will be discussed with respect to color matching unit 316 of FIG. 3, although method 1200 may be performed by other systems, not shown.

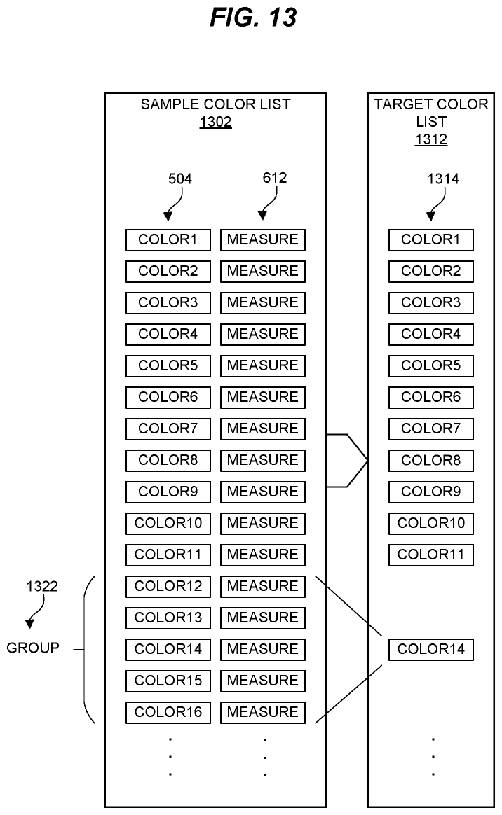

In general, method 1200 describes an operation workflow for a patch chart generation process where color matching unit 316 processes or evaluates the color measurements 612 for the color sample 502. In FIG. 12A, color matching unit 316 processes the color measurements 612 of the color sample 502 to select target colors from the color sample 502 (step 1202). A target color comprises a color 504 (or group of colors 504) in the color sample 502 selected for color matching. Color matching unit 316 may select each of the colors 504 from the color sample 502 as the target colors (optional step 1206), or may select a subset of the colors 504 from the color sample 502 as target colors (optional step 1208). FIG. 13 is a diagram illustrating a sample color list 1302 and a target color list 1312 in an illustrative embodiment. Sample color list 1302 represents each color 504 of the color sample 502 identified based on the color measurements 612, and target color list 1312 represents target colors 1314 selected from the color sample 502 for color matching.

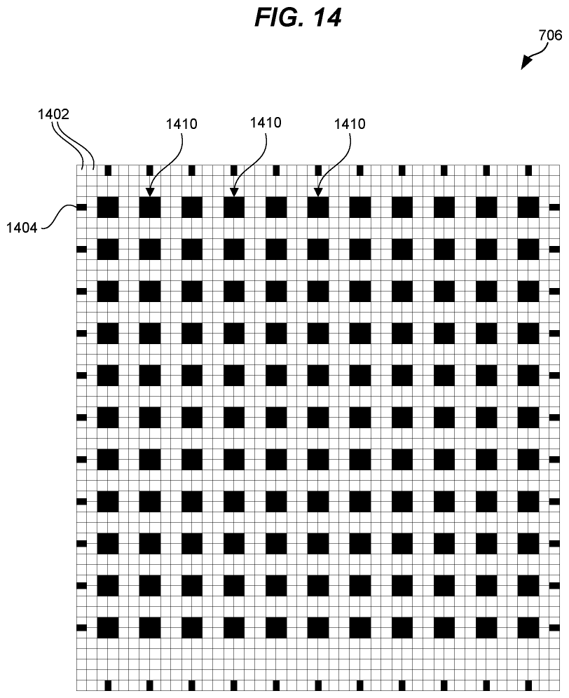

In FIG. 12A, color matching unit 316 generates the patch chart image 706 comprising color patch objects corresponding with the target colors 1314 (step 1204). FIG. 14 is a diagram illustrating a patch chart image 706 in an illustrative embodiment. Patch chart image 706 is illustrated as an array of pixels 1402, and comprises a plurality of color patch objects 1410 distributed among the pixels 1402. The color patch objects 1410 correspond with the target colors 1314 selected by color matching unit 316 (i.e., some or all of the colors 504 of the color sample 502). A color patch object 1410 therefore comprises a contiguous set of pixels or dots assigned the same target color value. In an embodiment, patch chart image 706 comprises one color patch object 1410 per target color 1314. The color patch objects 1410 may be arranged in rows and columns as indicated in FIG. 14, however the layout of the color patch objects 1410 may vary as desired. The color patch objects 1410 may each have a size (e.g., greater than 7 mm×7 mm) and geometry (e.g., square or rectangular) that is readable by a scanner 116 or the like. Patch chart image 706 may further include row/column marker objects 1404 to delineate individual rows and columns of color patch objects 1410.

Color matching unit 316 may select the target colors 1314 in a variety of ways or according to different criteria or policy, one of which is shown in FIG. 12B. In FIG. 12B, color matching unit 316 generates the target color list 1312 based on colors 504 of the color sample 502 identified based on the color measurements 612 (step 1214). For example, there may be a single appearance or multiple appearances of a color 504 (i.e., a distinct CMYK value 614) in the color measurements 612. Thus, color matching unit 316 may initially include (e.g., all) the colors 504 from the color sample 502 as target colors 1314 in the target color list 1312 (optional step 1222 in FIG. 12B). In FIG. 13, for example, Color1-Color16 illustrate distinct colors found in color sample 502 that are included as target colors 1314. There may be appearances of colors 504 that are very close in value in the color measurements 612. Thus, color matching unit 316 may group multiple colors 504 from the color sample 502 that are within a threshold color range as a target color 1314 (optional step 1224 in FIG. 12B). For example, one color 504 may have a CMYK value 614=C1, M1, Y1, K1, another color 504 may have a CMYK value 614=C1, M1+1, Y2, K2, and yet another color 504 may have a CMYK value 614=C1, M1+2, Y2, K2). When these colors 504 are within a threshold color range (e.g., C+/−5, M+/−5, Y+/−5, K+/−5), color matching unit 316 may group these colors 504 together in the target color list 1312 as a single target color 1314. In FIG. 13, for example, Color12-Color16 illustrate a group 1322 of colors 504 from the color sample 502 that are grouped or merged into a target color 1314.

In FIG. 12B, color matching unit 316 may filter the target color list 1312 based on filter criteria (step 1216). In an embodiment, the filter criteria may exclude certain target colors 1314 from the target color list 1312 that are less influential to the color matching process than other colors. For example, color matching unit 316 may exclude pure CMYK white and/or CMYK black from the target colors 1314 in the target color list 1312 (optional step 1226). In another example, color matching unit 316 may exclude colors 504 that appear less than a threshold value in the color sample 502 (optional step 1228). For example, color matching unit 316 may count the number of times of each color 504 appears in the color sample 502 based on the color measurements 612, and may compare the counts to a configurable threshold amount (also referred to as a count threshold, a percentage threshold, etc.). Color matching unit 316 may include colors 504 from the color sample 502 having a count greater than or equal to the threshold amount as target colors 1314, and may exclude colors 504 from the color sample 502 having a count lower than the threshold amount. For instance, color matching unit 316 may exclude colors 504 having a count less than ten, twenty, fifty, etc., a count representing less than a threshold percentage of overall colors 504, such as 0.5%, 1%, 2%, etc., or some other metric. Color matching unit 316 may use other filter criteria to filter the target color list 1312.

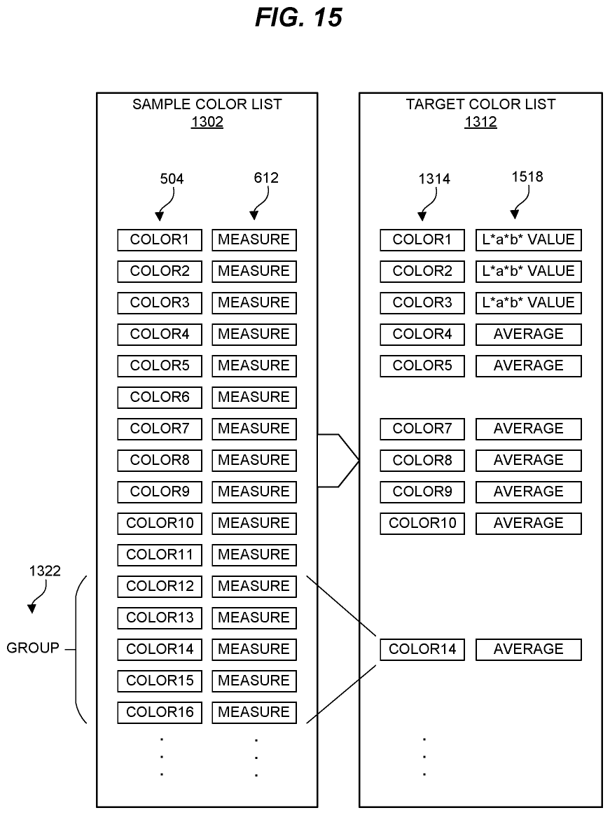

Color matching unit 316 assigns color match values to the target colors 1314 in the target color list 1312 (step 1218). A color match value for a target color 1314 is the value to be matched when reproducing that target color 1314 at a printer. In FIG. 12C, for example, for each target color 1314, color matching unit 316 may perform the following. When there is a single appearance of a target color 1314 in the color sample 502, the color match value of the target color 1314 is the L*a*b* value 616 associated with the target color 1314 (step 1230). FIG. 15 is a diagram illustrating the sample color list 1302 and the target color list 1312 in an illustrative embodiment. In this example, Color1-Color3 represent target colors 1314 that appear a single time in the color sample 502, so the color match value 1518 is the L*a*b* value 616 associated with the target color 1314.

In FIG. 12C, when there are multiple appearances of a target color 1314 in the color sample 502, color matching unit 316 calculates an average of the L*a*b* values 616 over the multiple appearances of the target color 1314 in the color sample 502 as the color match value 1518 of the target color 1314 (step 1232). For example, a target color 1314 (having a certain CMYK value 614) may appear multiple times in the color sample 502, and the L*a*b* values 616 corresponding with each instance of a target color 1314 may be slightly different. Thus, color matching unit 316 may average the L*a*b* values 616 over the individual instances of the target color 1314 appearing in the color sample 502 to determine an average value. In FIG. 15, for example, Color4-Color5 and Color7-Color10 represent target colors 1314 that appear multiple times in the color sample 502, so the color match value 1518 is an average of the L*a*b* values 616 associated with the target color 1314.

In FIG. 12C, when grouping multiple colors 504 from the color sample 502 together into a target color 1314, color matching unit 316 calculates an average value of the L*a*b* values 616 over the multiple colors 504 as the color match value 1518 for the corresponding target color 1314 (step 1234). In FIG. 15, for example, Color12-Color16 are grouped into a single target color 1314 (i.e., Color14). Color matching unit 316 may average the L*a*b* values 616 over the individual colors 504 in the group 1322 to determine an average value.

It is also noted that FIG. 15 illustrates some target colors 1314 (i.e., Color6 and Color11) have been removed due to filtering.

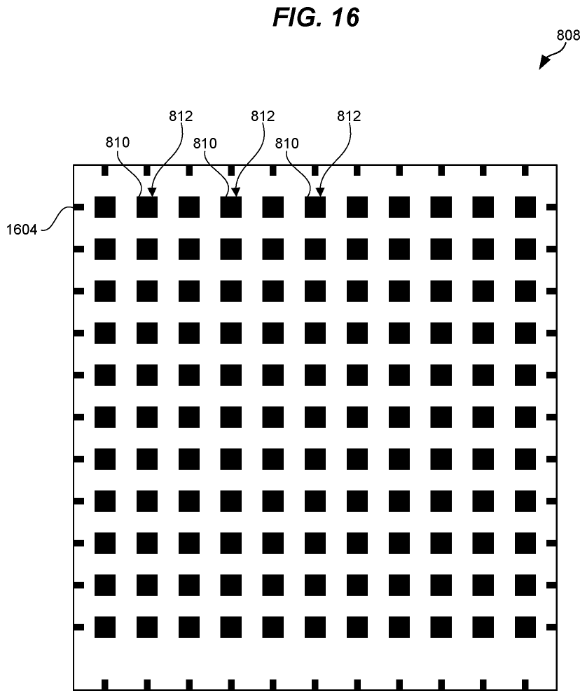

Color matching unit 316 generates the patch chart image 706 comprising color patch objects 1410 corresponding with the target colors 1314 (see step 1204 of FIG. 12A). The patch chart image 706 is then printed at a target printer 106 to output a patch chart (see step 406 of FIG. 4). FIG. 16 is a diagram illustrating a patch chart 808 in an illustrative embodiment. Patch chart 808 comprises (physical) printed output from the target printer 106, such as one or more sheets of paper. Patch chart 808 comprises a plurality of color patches 810 representing actual colors 812 reproduceable by the target printer 106 based on the target colors 1314 identified for the color matching process. In an embodiment, patch chart 808 comprises one color patch 810 per target color 1314. The color patches 810 may be arranged in rows and columns as indicated in FIG. 16, however the layout of the color patches 810 may vary as desired. The color patches 810 may each have a size (e.g., greater than 7 mm×7 mm) and geometry (e.g., square or rectangular) that is readable by a scanner 116 or the like. Patch chart 808 may further include row/column markers 1604 to delineate individual rows and columns of color patches 810.

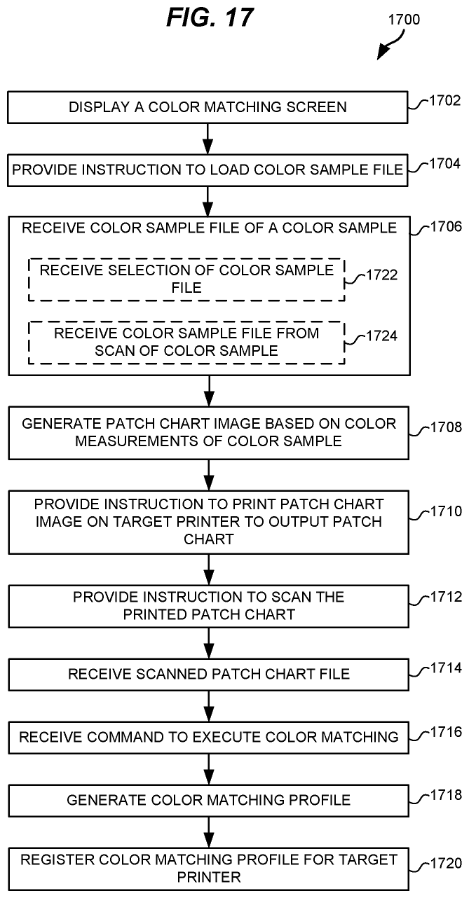

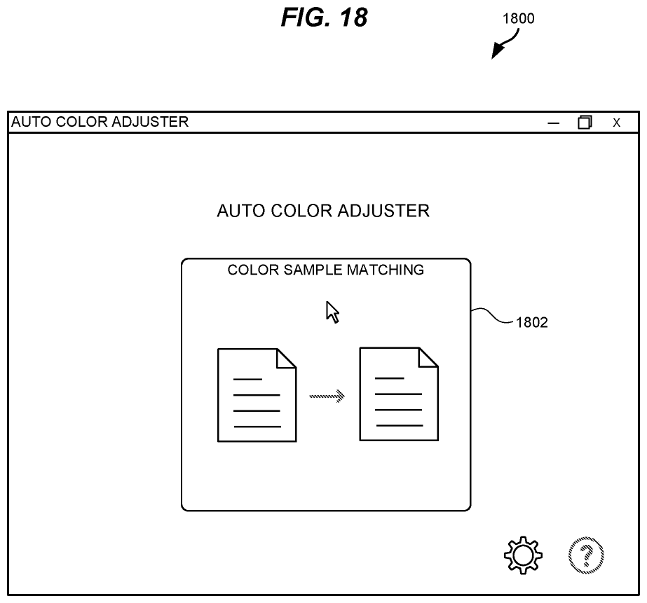

FIG. 17 is a flow chart illustrating a method 1700 of color matching within color matching unit 316 in an illustrative embodiment. In general, method 1700 describes an operation workflow for color matching within color matching unit 316. Color matching unit 316 may provide a website, a portal, a dashboard, GUI 344, or some other digital or graphical interface configured to interact with a user. For example, a GUI 344 provided by color matching unit 316 may include icons, graphic representations or graphical elements, windows, screens, etc. Color matching unit 316 displays a color matching screen (step 1702) allowing a user, requestor, or operator to initiate a color matching process. FIG. 18 is a diagram illustrating a color matching screen 1800 in an illustrative embodiment. Color matching screen 1800 displays one or more graphical elements 1802 that allow a user to initiate the color matching process for a target printer 106.

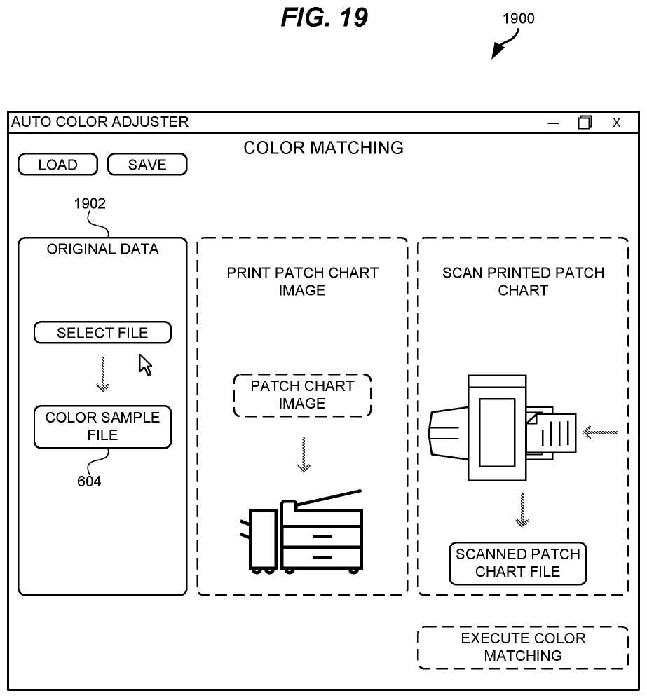

In FIG. 17, color matching unit 316 provides an instruction, command, or request to a user to load a color sample file 604 (step 1704). FIG. 19 is a diagram illustrating a color matching screen 1900 in an illustrative embodiment. Color matching screen 1900 displays a graphical element 1902 that instructs the user to load a color sample file 604. In response to the instruction, color matching unit 316 receives the color sample file 604 (step 1706). As described above, a color sample 502 may have been previously scanned and processed to generate color sample file 604, which is stored in memory. Therefore, color matching screen 1900 may allow the user to select the color sample file 604 from a memory location (optional step 1722). In another example, the color sample 502 may be scanned and processed (e.g., at scanner 116) to generate a color sample file 604, which is received (e.g., automatically) by color matching unit 316 (optional step 1724). Color matching screen 1900 may display a thumbnail image of the color sample file 604 selected or display other information regarding the color sample file 604.

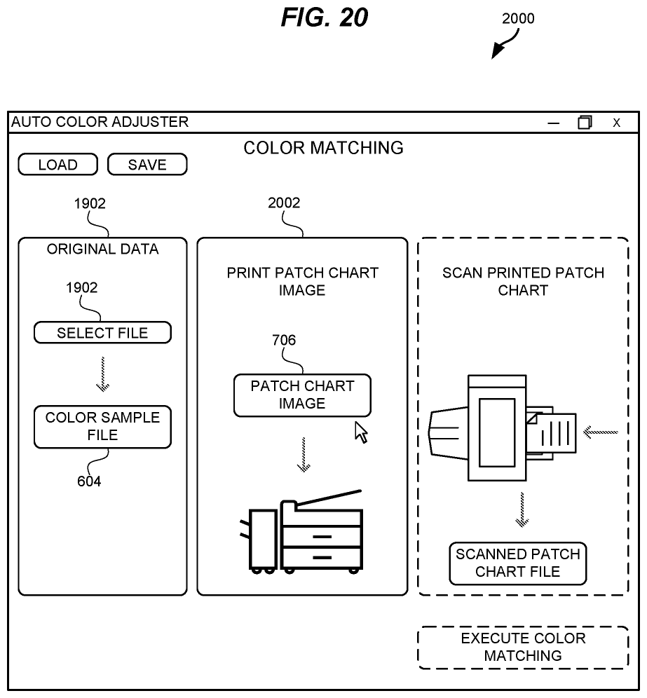

In FIG. 17, color matching unit 316 generates a patch chart image 706 based on the color measurements 612 of the color sample 502 (step 1708). Operations for generating the patch chart image 706 were described above in step 404 of FIG. 4 and will not be repeated for the sake of brevity. Color matching unit 316 provides an instruction, command, or request to the user to print the patch chart image 706 at the target printer 106 (step 1710). FIG. 20 is a diagram illustrating a color matching screen 2000 in an illustrative embodiment. Color matching screen 2000 displays a graphical element 2002 that instructs the user to print the patch chart image 706. When the user makes a selection to print the patch chart image 706, color matching unit 316 may send the patch chart image 706 to the target printer 106, which in turn prints the patch chart image 706 to generate or output a patch chart 808.

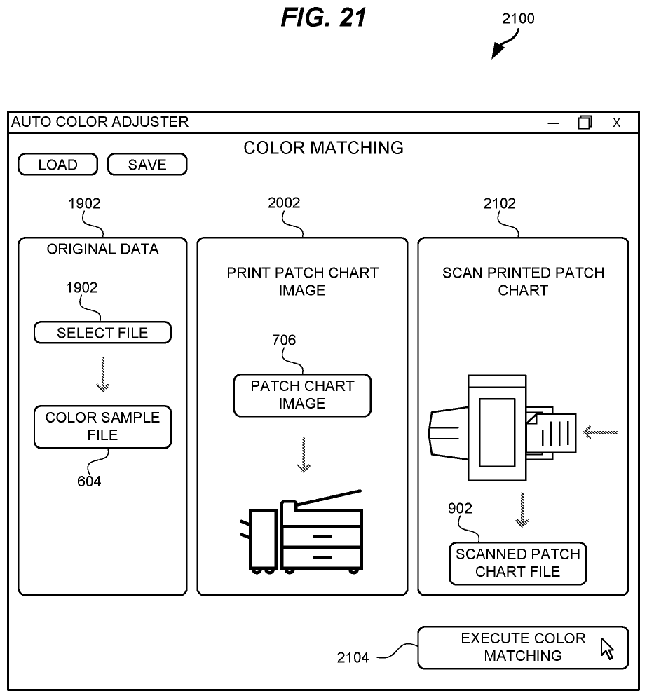

In FIG. 17, color matching unit 316 provides an instruction, command, or request to the user to scan the printed patch chart 808 (step 1712). FIG. 21 is a diagram illustrating a color matching screen 2100 in an illustrative embodiment. Color matching screen 2100 displays a graphical element 2102 that instructs the user to scan the printed patch chart 808. In response to scanning of the printed patch chart 808, such as at scanner 116, color matching unit 316 receives a scanned patch chart file 902 (see step 1714 of FIG. 17). In FIG. 17, color matching unit 316 receives an instruction, command, or selection from the user to execute color matching (step 1716). In FIG. 21, for example, a user may select an execute button 2104 or icon on color matching screen 2100 to execute color matching. Color matching unit 316 then generates a color matching profile 320 for the target printer 106 based on the color measurements 612 for the color sample 502 and the color measurements 912 for the patch chart 808 printed at the target printer 106 (step 1718). Color matching unit 316 may then register the color matching profile 320 at the target printer 106 for color-matched printing (step 1720). One technical benefit is color matching unit 316 provides a user-friendly interface to implement color matching for a printer 106.

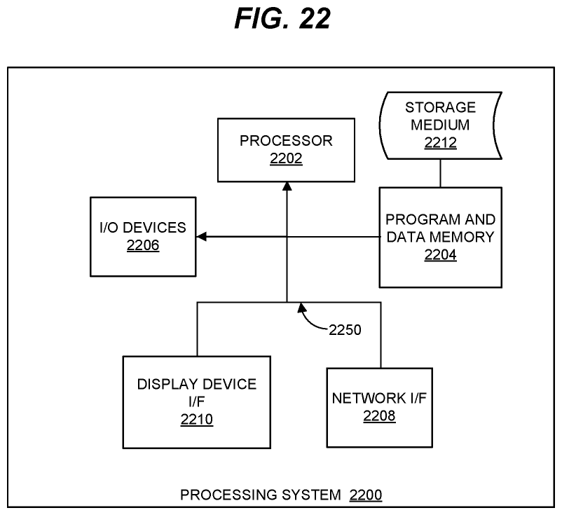

Embodiments disclosed herein can take the form of software, hardware, firmware, or various combinations thereof. FIG. 22 illustrates a processing system 2200 operable to execute a computer readable medium embodying programmed instructions to perform desired functions in an illustrative embodiment. Processing system 2200 is operable to perform the above operations by executing programmed instructions tangibly embodied on computer readable storage medium 2212. In this regard, embodiments of the invention can take the form of a computer program accessible via computer-readable medium 2212 providing program code for use by a computer or any other instruction execution system. For the purposes of this description, computer readable storage medium 2212 can be anything that can contain or store the program for use by the computer.

Computer readable storage medium 2212 can be an electronic, magnetic, optical, electromagnetic, infrared, or semiconductor device. Examples of computer readable storage medium 2212 include a solid-state memory, a magnetic tape, a removable computer diskette, a random-access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 2200, being suitable for storing and/or executing the program code, includes at least one processor 2202 coupled to program and data memory 2204 through a system bus 2250. Program and data memory 2204 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 2206 (including but not limited to keyboards, displays, pointing devices, etc.) can be coupled either directly or through intervening I/O controllers. Network adapter interfaces 2208 may also be integrated with the system to enable processing system 2200 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 2210 may be integrated with the system to interface to one or more display devices, such as printing systems and screens for presentation of data generated by processor 2202.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes a method of color matching. The method comprises loading a color sample file of a color sample, wherein the color sample file includes color measurements for the color sample. The method comprises generating a patch chart image by: processing the color measurements for the color sample to select target colors from the color sample, and generating the patch chart image comprising color patch objects corresponding with the target colors. The method comprises printing the patch chart image at a target printer to output a patch chart that includes a plurality of color patches corresponding with the color patch objects, scanning the patch chart to generate color measurements for the patch chart, generating a color matching profile for the target printer based on the color measurements for the color sample and the color measurements for the patch chart, and registering the color matching profile at the target printer for color-matched printing at the target printer.

Example 2 includes the subject matter of Example 1, where the patch chart image comprises one color patch object per target color.

Example 3 includes the subject matter of Examples 1 and 2, where the processing the color measurements for the color sample comprises selecting each color from the color sample as the target colors.

Example 4 includes the subject matter of Examples 1-3, where the processing the color measurements for the color sample comprises selecting a subset of colors from the color sample as the target colors.

Example 5 includes the subject matter of Examples 1-4, where the selecting comprises grouping multiple colors of the color sample within a threshold color range as one of the target colors.

Example 6 includes the subject matter of Example 1-5, further comprising assigning a color match value to the one of the target colors by calculating an average of L*a*b* values over the multiple colors of the color sample.

Example 7 includes the subject matter of Examples 1-6, where the selecting comprises excluding, from the target colors, colors of the color sample that appear less than a threshold amount in the color sample.

Example 8 includes the subject matter of Examples 1-7, further comprising assigning a color match value to one of the target colors having multiple appearances in the color sample by calculating an average of L*a*b* values over the multiple appearances.

Some embodiments pertain to Example 9 that includes a color matching apparatus comprising at least one processor and memory. The at least one processor is configured to cause the color matching apparatus at least to receive a color sample file of a color sample, wherein the color sample file includes color measurements for the color sample. The at least one processor is configured to cause the color matching apparatus at least to generate a patch chart image by processing the color measurements for the color sample to select target colors from the color sample, and generating the patch chart image comprising color patch objects corresponding with the target colors. The at least one processor is configured to cause the color matching apparatus at least to provide an instruction to print the patch image at a target printer to output a patch chart, wherein the patch chart includes a plurality of color patches corresponding with the color patch objects. The at least one processor is configured to cause the color matching apparatus at least to provide an instruction to scan the patch chart to generate color measurements for the patch chart, receive the color measurements for the patch chart, generate a color matching profile for the target printer based on the color measurements for the color sample and the color measurements for the patch chart, and register the color matching profile at the target printer for color-matched printing at the target printer.

Example 10 includes the subject matter of Example 9, where the patch chart image comprises one color patch object per target color.

Example 11 includes the subject matter of Examples 9 and 10, where the at least one processor is further configured to cause the color matching apparatus at least to select a subset of colors from the color sample as the target colors.

Example 12 includes the subject matter of Examples 9-11, where the at least one processor is further configured to cause the color matching apparatus at least to group multiple colors of the color sample within a threshold color range as one of the target colors.

Example 13 includes the subject matter of Examples 9-12 where the at least one processor is further configured to cause the color matching apparatus at least to assign a color match value to the one of the target colors by calculating an average of L*a*b* values over the multiple colors of the color sample.

Example 14 includes the subject matter of Examples 9-13, where the at least one processor is further configured to cause the color matching apparatus at least to exclude, from the target colors, colors of the color sample that appear less than a threshold amount in the color sample.

Example 15 includes the subject matter of Examples 9-14, where the at least one processor is further configured to cause the color matching apparatus at least to assign a color match value to one of the target colors having multiple appearances in the color sample by calculating an average of L*a*b* values over the multiple appearances.

Example 16 includes the subject matter of Examples 9-15, where a printing system comprises the color matching apparatus and the target printer.

Example 17 includes the subject matter of Examples 9-16, where a printing system comprises the color matching apparatus, the target printer, and a scanner configured to scan the patch chart.

Some embodiments pertain to Example 18 that includes a method of color matching. The method comprises receiving, at a color matching apparatus, a color sample file of a color sample, wherein the color sample file includes color measurements for the color sample. The method comprises generating a patch chart image at the color matching apparatus by processing the color measurements for the color sample to select target colors from the color sample, and generating the patch chart image comprising color patch objects corresponding with the target colors. The method comprises providing, at the color matching apparatus, an instruction to print the patch image at a target printer to output a patch chart, wherein the patch chart includes a plurality of color patches corresponding with the color patch objects. The method comprises providing, at the color matching apparatus, an instruction to scan the patch chart to generate color measurements for the patch chart, receiving, at the color matching apparatus, the color measurements for the patch chart, generating, at the color matching apparatus, a color matching profile for the target printer based on the color measurements for the color sample and the color measurements for the patch chart, and registering the color matching profile at the target printer for color-matched printing at the target printer.

Example 19 includes the subject matter of Example 18, where the patch chart image comprises one color patch object per target color.

Example 20 includes the subject matter of Examples 18 and 19, where the processing the color measurements for the color sample comprises selecting a subset of colors from the color sample as the target colors.

Although specific embodiments were described herein, the scope of the invention is not limited to those specific embodiments. The scope of the invention is defined by the following claims and any equivalents thereof.

What is claimed is:

1. A method of color matching, the method comprising:
loading a color sample file of a color sample, wherein the color sample file includes color measurements for the color sample;
generating a patch chart image by:
processing the color measurements for the color sample to select target colors from the color sample; and
generating the patch chart image comprising color patch objects corresponding with the target colors;
printing the patch chart image at a target printer to output a patch chart that includes a plurality of color patches corresponding with the color patch objects;
scanning the patch chart to generate color measurements for the patch chart;
generating a color matching profile for the target printer based on the color measurements for the color sample and the color measurements for the patch chart; and
registering the color matching profile at the target printer for color-matched printing at the target printer.

2. The method of claim 1, wherein:
the patch chart image comprises one color patch object per target color.

3. The method of claim 1, wherein the processing the color measurements for the color sample comprises:
selecting each color from the color sample as the target colors.

4. The method of claim 1, wherein the processing the color measurements for the color sample comprises:
selecting a subset of colors from the color sample as the target colors.

5. The method of claim 4, wherein the selecting comprises:
grouping multiple colors of the color sample within a threshold color range as one of the target colors.

6. The method of claim 5, further comprising:
assigning a color match value to the one of the target colors by calculating an average of L*a*b* values over the multiple colors of the color sample.

7. The method of claim 4, wherein the selecting comprises:
excluding, from the target colors, colors of the color sample that appear less than a threshold amount in the color sample.

8. The method of claim 1, further comprising:
assigning a color match value to one of the target colors having multiple appearances in the color sample by calculating an average of L*a*b* values over the multiple appearances.

9. A color matching apparatus, comprising:
at least one processor and memory, wherein the at least one processor is configured to cause the color matching apparatus at least to:
receive a color sample file of a color sample, wherein the color sample file includes color measurements for the color sample;
generate a patch chart image by:
processing the color measurements for the color sample to select target colors from the color sample; and
generating the patch chart image comprising color patch objects corresponding with the target colors;
provide an instruction to print the patch image at a target printer to output a patch chart, wherein the patch chart includes a plurality of color patches corresponding with the color patch objects;
provide an instruction to scan the patch chart to generate color measurements for the patch chart;
receive the color measurements for the patch chart;
generate a color matching profile for the target printer based on the color measurements for the color sample and the color measurements for the patch chart; and
register the color matching profile at the target printer for color-matched printing at the target printer.

10. The color matching apparatus of claim 9, wherein:
the patch chart image comprises one color patch object per target color.

11. The color matching apparatus of claim 9, wherein the at least one processor is further configured to cause the color matching apparatus at least to:
select a subset of colors from the color sample as the target colors.

12. The color matching apparatus of claim 11, wherein the at least one processor is further configured to cause the color matching apparatus at least to:
group multiple colors of the color sample within a threshold color range as one of the target colors.

13. The color matching apparatus of claim 12, wherein the at least one processor is further configured to cause the color matching apparatus at least to:
assign a color match value to the one of the target colors by calculating an average of L*a*b* values over the multiple colors of the color sample.

14. The color matching apparatus of claim 11, wherein the at least one processor is further configured to cause the color matching apparatus at least to:
exclude, from the target colors, colors of the color sample that appear less than a threshold amount in the color sample.

15. The color matching apparatus of claim 9, wherein the at least one processor is further configured to cause the color matching apparatus at least to:
assign a color match value to one of the target colors having multiple appearances in the color sample by calculating an average of L*a*b* values over the multiple appearances.

16. A printing system, comprising:
the color matching apparatus of claim 9; and
the target printer.

17. A printing system, comprising:
the color matching apparatus of claim 9;
the target printer; and
a scanner configured to scan the patch chart.

18. A method of color matching, the method comprising:
receiving, at a color matching apparatus, a color sample file of a color sample, wherein the color sample file includes color measurements for the color sample;
generating a patch chart image at the color matching apparatus by:
processing the color measurements for the color sample to select target colors from the color sample; and
generating the patch chart image comprising color patch objects corresponding with the target colors;
providing, at the color matching apparatus, an instruction to print the patch image at a target printer to output a patch chart, wherein the patch chart includes a plurality of color patches corresponding with the color patch objects;
providing, at the color matching apparatus, an instruction to scan the patch chart to generate color measurements for the patch chart;
receiving, at the color matching apparatus, the color measurements for the patch chart;
generating, at the color matching apparatus, a color matching profile for the target printer based on the color measurements for the color sample and the color measurements for the patch chart; and
registering the color matching profile at the target printer for color-matched printing at the target printer.

19. The method of claim 18, wherein:
the patch chart image comprises one color patch object per target color.

20. The method of claim 18, wherein the processing the color measurements for the color sample comprises:
selecting a subset of colors from the color sample as the target colors.
